(19) United States
(12) Patent Application Publication
(10) Pub. No.: US 2022/0356953 A1
(43) Pub. Date: Nov. 10, 2022

(54) OPERATION VALVE

(71) Applicant: FUMOTO GIKEN CO., LTD., Miura-gun (JP)

(72) Inventor: Ryohei YAMAMOTO, Miura-gun (JP)

(73) Assignee: FUMOTO GIKEN CO., LTD., Miura-gun (JP)

(21) Appl. No.: 17/470,847

(22) Filed: Sep. 9, 2021

(30) Foreign Application Priority Data
May 10, 2021 (JP) 2021-079994

(51) Int. Cl. F16K 5/06; F16K 35/02; F16K 27/06; F01M 11/04; F01M 11/00

(52) U.S. Cl. CPC F16K 5/0647; F16K 35/027; F16K 27/067; F01M 11/0408; F01M 11/0004

(57) ABSTRACT

An operation valve includes a valve that controls the flow of a fluid, a cylindrical operator that operates opening and closing of the valve by rotating the operator in a peripheral direction, and has a first step parallel to a central axis of the operator, a storage that stores the valve, includes a flow channel of the fluid therein, and has a second step corresponding to the first step on an outer periphery of the storage in a first state in which the valve is closed, and an elastic body that urges the operator toward the storage.

### CROSS-REFERENCE TO RELATED APPLICATION

This application is based upon and claims the benefit of priority of the prior Japanese Patent Application No. 2021-079994, filed on May 10, 2021, the entire contents of which are incorporated herein by reference.

### TECHNICAL FIELD

The present disclosure relates to an operation valve.

### BACKGROUND

An oil pan is provided at the bottom of an engine mounted on a motorcycle, an automobile, a heavy machinery, or the like. Oil that lubricates pistons and other parts of the engine is stored in the oil pan. The oil is changed regularly. When changing the oil, a tool such as a spanner is used to remove a screw lid of a drain port provided at the bottom of the oil pan.

When the screw lid of the drain port is removed, the oil spurts out at the same time. This may cause an operator's body to become dirty with the oil. When closing the drain port with the screw lid after the oil has been drained, the screw lid and the tools may be covered with the oil, and it may take time and effort to attach the screw lid to the drain port.

As a device for eliminating such inconveniences associated with oil change, there is known an operation valve that can be attached to the drain port as well as the screw lid. The operation valve is always attached to the drain port, and the opening and closing of the valve can be controlled by rotating an operation cock. In the normal state, the operation cock is maintained in a closed state and the valve is closed. When the operation cock is rotated in the open state, the valve opens and the oil is discharged. Note that the technique related to the present disclosure is disclosed in Japanese Laid-open Patent Publications No. 2002-106731, No 2017-36828 and No. 2020-112259.

### SUMMARY

An object of the present disclosure is to provide an operation valve including: a valve that controls the flow of a fluid; a cylindrical operator that operates opening and closing of the valve by rotating the operator in a peripheral direction, and has a first step parallel to a central axis of the operator; a storage that stores the valve, includes a flow channel of the fluid therein, and has a second step corresponding to the first step on an outer periphery of the storage in a first state in which the valve is closed; and an elastic body that urges the operator toward the storage.

### BRIEF DESCRIPTION OF THE DRAWINGS

FIG. 1A is a first perspective view illustrating an example of attaching the operation valve to the oil pan according to the first embodiment;

FIG. 1B is a second perspective view illustrating an example of attaching the operation valve to the oil pan according to the first embodiment;

FIG. 2A is a first perspective view illustrating a first state of the operation valve according to the first embodiment;

FIG. 2B is a second perspective view illustrating the first state of the operation valve according to the first embodiment;

FIG. 2C is a cross-sectional view taken along line Z1-Z1 illustrating the first state of the operation valve according to the first embodiment;

FIG. 3A is a first perspective view illustrating a second state of the operation valve according to the first embodiment;

FIG. 3B is a second perspective view illustrating the second state of the operation valve according to the first embodiment;

FIG. 3C is a cross-sectional view taken along line Z2-Z2 illustrating the second state of the operation valve according to the first embodiment;

FIG. 4 is a perspective view illustrating an example of attaching the operation valve to the oil pan according to a second embodiment;

FIG. 5A is a first perspective view illustrating the first state of the operation valve according to the second embodiment;

FIG. 5B is a second perspective view illustrating the first state of the operation valve according to the second embodiment;

FIG. 5C is a cross-sectional view taken along line Z3-Z3 illustrating the first state of the operation valve according to the second embodiment;

FIG. 6 is an exploded perspective view of an operation mechanism of the operation valve according to the second embodiment;

FIG. 7A is a first perspective view illustrating an intermediate state of the operation valve according to the second embodiment;

FIG. 7B is a second perspective view illustrating the intermediate state of the operation valve according to the second embodiment;

FIG. 7C is a cross-sectional view taken along line Z4-Z4 illustrating the intermediate state of the operation valve according to the second embodiment;

FIG. 8A is a first perspective view illustrating the second state of the operation valve according to the second embodiment;

FIG. 8B is a second perspective view illustrating the second state of the operation valve according to the second embodiment;

FIG. 8C is a cross-sectional view taken along line Z5-Z5 illustrating the second state of the operation valve according to the second embodiment;

FIG. 9A is a first perspective view illustrating the second state of the operation valve according to a third embodiment;

FIG. 9B is a second perspective view illustrating the second state of the operation valve according to the third embodiment;

FIG. 9C is a cross-sectional view taken along line Z6-Z6 illustrating the first state of the operation valve according to the third embodiment;

FIG. 10 is an exploded perspective view of the operation valve according to the third embodiment;

FIG. 11A is a first perspective view illustrating the intermediate state of the operation valve according to the third embodiment;

FIG. 11B is a second perspective view illustrating the intermediate state of the operation valve according to the third embodiment;

FIG. 11C is a cross-sectional view taken along line Z7-Z7 illustrating the intermediate state of the operation valve according to the third embodiment;

FIG. 12A is a first perspective view illustrating the second state of the operation valve according to the third embodiment;

FIG. 12B is a second perspective view illustrating the second state of the operation valve according to the third embodiment; and

FIG. 12C is a cross-sectional view taken along line Z8-Z8 illustrating the second state of the operation valve according to the third embodiment.

### DETAILED DESCRIPTION

However, when the operation cock is adopted as the operation valve, various inconveniences may occur due to the operation valve being attached to the drain port in the same manner as the screw lid. For example, when the operation valve is attached to the drain port, the operation cock may face toward the bottom surface of the oil pan. In this case, the operation of the operation cock may be hindered.

When the operation valve is attached to the drain port, the operation cock may face toward the ground. In this case, the operation cock may come into contact with foreign matters on the road while the vehicle is traveling, and the operation cock may be damaged. In addition, if the vehicle is moving in snow, the operation cock may accidentally rotate due to the compressed snow, and a valve may open.

It is an object of the present disclosure to provide an operation valve that eliminates inconvenience associated with the operation cock.

A description will be given of embodiments of the present disclosure, with reference to drawings.

### FIRST EMBODIMENT

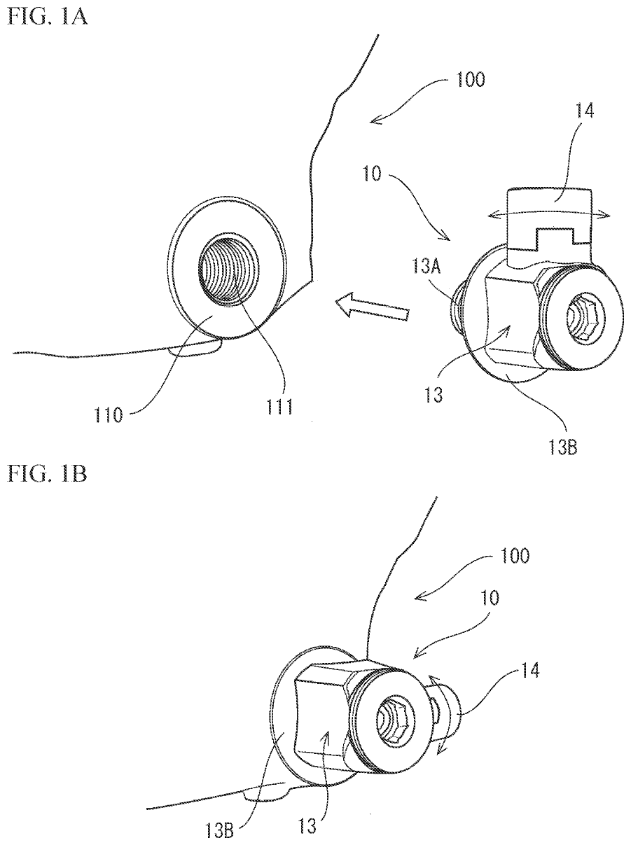

First, an operation valve 10 will be described. As illustrated in FIG. 1A, the operation valve 10 is attached to a drain port 110 provided at the bottom of an oil pan 100. The oil pan 100 is a container for storing an oil. The drain port 110 is an opening for discharging the oil stored in the oil pan 100. The oil is a lubricating oil that lubricates pistons and other parts in an engine mounted on a motorcycle, an automobile, a heavy machinery, or the like. A female screw 111 is provided on an inner peripheral surface of the drain port 110.

The operation valve 10 has a storage portion 13 for storing a valve (specifically, a ball valve). The storage portion 13 has a flow channel for the oil therein. Therefore, the storage portion 13 is cylindrical. The valve of the storage portion 13 controls the flow of the oil. A male screw 13A is provided at one end of the storage portion 13 via a flange 13B. A circular through hole is provided in the central of the flange 13B. The male screw 13A is provided with a flow passage of the oil along a longitudinal direction of the male screw 13A. That is, the male screw 13A is hollow along the longitudinal direction. The flow channel of the storage portion 13 is coupled with the through hole of the flange 13B and the flow passage of the male screw 13A.

When attaching the operation valve 10 to the drain port 110, the operator, for example, grasps the storage portion 13 of the operation valve 10 with two fingers of one hand, brings the male screw 13A of the operation valve 10 into contact with the drain port 110, and turns the operating valve 10 clockwise to screw the male screw 13A into the drain port 110. Thereby, the male screw 13A and the female screw 111 of the drain port 110 are fastened, and the operation valve 10 can be attached to the drain port 110 as illustrated in FIG. 1B.

The valve of the storage portion 13 can be opened and closed by rotating a bottomed cylindrical operation dial 14, which is provided as an operator on an outer peripheral surface of the storage portion 13, in a peripheral direction. For example, when the valve is closed as a first state and the operation dial 14 is rotated counterclockwise in the peripheral direction, the valve opens. Thereby, the oil discharged from the drain port 110 is discharged from the operation valve 10 through the flow passage of the male screw 13A, the through hole of the flange 13B, and the flow channel of the storage portion 13.

Conversely, when the valve is open as a second state and the operation dial 14 is rotated clockwise in the peripheral direction, the valve closes. Thereby, the oil discharged from the drain port 110 stays in front of the valve in the flow channel of the storage portion 13. As a result, the discharge of the oil from the operation valve 10 is stopped.

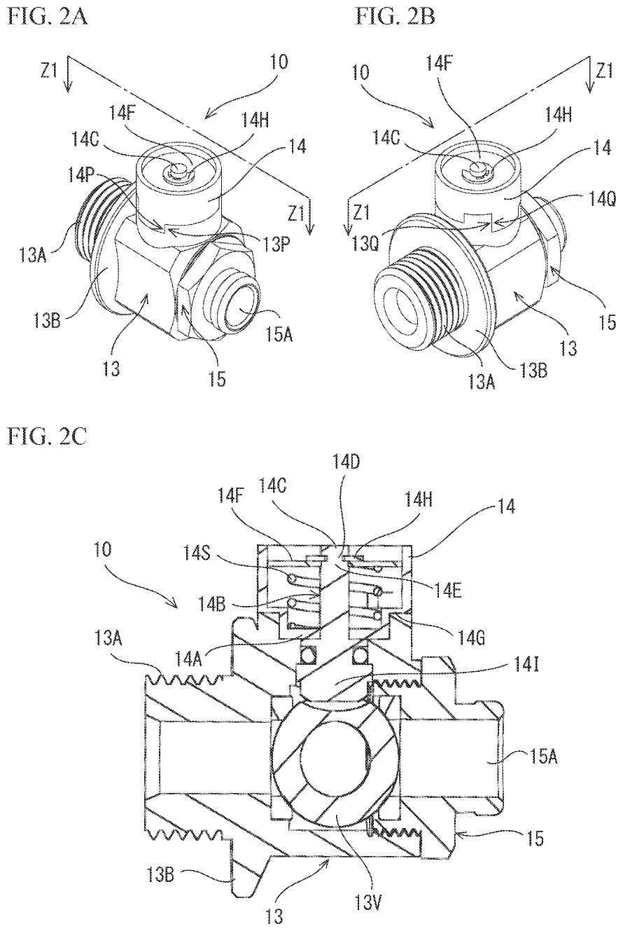

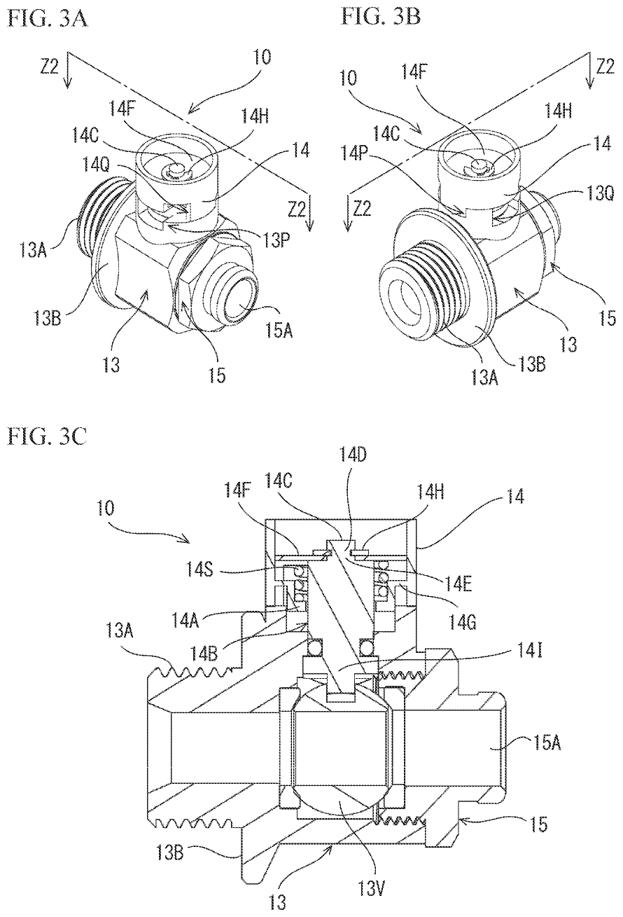

The details of the operation valve 10 will be described with reference to FIGS. 2A to 2C and FIGS. 3A to 3C. FIGS. 2A to 2C illustrate the operation valve 10 in the first state in which a valve 13V is closed. FIGS. 3A to 3C illustrate the operation valve 10 in the second state in which the valve 13V is opened.

First, as illustrated in FIGS. 2A and 2B, the operation dial 14 includes dial steps 14P and 14Q along the peripheral direction, as first steps parallel to a central axis. On the other hand, the storage portion 13 includes storage steps 13P and 13Q on an outer peripheral surface, as second steps corresponding to the dial steps 14P and 14Q in the first state in which the valve 13V is closed.

The heights of the dial step 14P and the storage step 13P are the same as each other. The heights of the dial step 14Q and the storage step 13Q are also the same as each other. However, the heights of the dial step 14P and the dial step 14Q are different from each other. Therefore, the heights of the storage step 13P and the storage step 13Q are also different from each other. Therefore, when the valve 13V is closed, the dial step 14P and the storage step 13P are fitted to each other, and the dial step 14Q and the storage step 13Q are fitted to each other.

As illustrated in FIG. 2C, the operation dial 14 has two-stage bottoms having different bottom depths, and a substantially rectangular opening is provided near the center of a deepest first bottom 14A. A spring (specifically, a coil spring) 14S as an elastic body having an outer diameter slightly smaller than or equal to an inner diameter of the first bottom 14A is arranged on the first bottom 14A. A stem 14B including a rectangular cross section equivalent to the opening of the first bottom 14A partially penetrates the opening of the first bottom 14A from the outside of the bottom to the inside of the bottom. The stem 14B extends along a central axis of the spring 14S in a direction away from the storage portion 13.

The cross sections of a stem head portion 14C on the opposite side of the valve 13V of the stem 14B and a stem neck portion 14D located directly below the stem head portion 14C are both circular. The diameter of the stem neck portion 14D is smaller than the diameter of the stem head portion 14C. On the other hand, the cross section of a stem shoulder portion 14E, which is located directly below the stem neck portion 14D, is also circular. The diameter of the stem shoulder portion 14E is equal to the diameter of the stem head portion 14C. This allows the stem 14B to be inserted into the opening of the first bottom 14A. The cross section of an insertion portion of a stem leg portion 14I located closer to the valve 13V than the stem shoulder portion 14E through the first bottom 14A is rectangular. Specifically, the rectangle of the insertion portion includes a short side equal to the diameter of the stem shoulder portion 14E and a long side larger than the diameter of the stem shoulder portion 14E.

A disc portion 14F with a circular opening slightly larger than or equal to the cross section of the stem shoulder portion 14E is placed above the spring 14S. The disk portion 14F is separate from the operation dial 14. The outer diameter of the disk portion 14F is equal to the inner diameter of a second bottom 14G. When the disk portion 14F is placed and pressed to the position of the stem shoulder portion 14E, an E-ring 14H can be attached to the stem neck portion 14D. When the disc portion 14F is pressed, the spring 14S having a natural length is compressed by the pressing of the disc portion 14F and has a restoring force.

The restoring force of the spring 14S also acts on the disc portion 14F, but the movement of the disc portion 14F toward the stem head portion 14C is regulated by attaching the E-ring 14H to the stem neck portion 14D. Thereby, the restoring force of the spring 14S always acts on the first bottom 14A. That is, the movement of the disc portion 14F toward the stem head portion 14C is regulated, so that the spring 14S always urges the operation dial 14 toward the storage portion 13. In this way, since the spring 14S urges the operation dial 14 toward the storage portion 13, the operation dial 14 and the storage portion 13 come into contact with each other with almost no gap in the first state in which the valve 13V is closed, as shown in FIGS. 2A and 2B. In particular, in the first state, the dial steps 14P and 14Q of the operation dial 14 and the storage steps 13P and 13Q provided on the outer peripheral surface of the storage portion 13 are fitted to each other, so that the rotation of the operation dial 14 in the peripheral direction can be regulated.

As shown in FIG. 2C, the valve 13V is coupled to the stem leg portion 14I of the stem 14B. A convex portion (not illustrated) having a rectangular cross section provided at the tip of the stem leg portion 14I and a concave portion (not illustrated) having a rectangular cross section provided near the stem leg portion 14I of the valve 13V are fitted to each other, so that the stem leg portion 14I and the valve 13V are coupled to each other.

When shifting from the first state in which the valve 13V is closed to the second state in which the valve 13V is open, the operation dial 14 is grasped by fingers and pulled up in a direction away from the operation valve 10. When the operation dial 14 is pulled up, an inner bottom surface of the first bottom 14A presses on the spring 14S, and the spring 14S compresses, as illustrated in FIG. 3C. Since the disk portion 14F is separate from the operation dial 14, the outer peripheral surface of the disk portion 14F slides on the inner peripheral surface of the operation dial 14. As the spring 14S is compressed, the fitting between the dial step 14P and the storage step 13P is released, and the dial step 14P is lifted to a height where it can overcome the storage step 13P. This allows the operation dial 14 to be rotated counterclockwise in the peripheral direction, as illustrated in FIGS. 3A and 3B.

When the operation dial 14 is rotated counterclockwise in the peripheral direction by a predetermined amount, the dial step 14P comes into contact with the storage step 13Q. When the dial step 14P reaches a height at which the storage step 13P can be overcome, the operation dial 14 cannot be further pulled up. That is, the operation dial 14 cannot be further pulled up to a height at which the dial step 14P can overcome the storage step 13Q. Therefore, the storage step 13Q can regulate the excessive rotation of the operation dial 14 exceeding a predetermined amount.

Further, when the operation dial 14 is rotated counterclockwise in the peripheral direction by the predetermined amount, the first bottom 14A also rotates in conjunction with the operation dial 14. The stem 14B is inserted through the opening of the first bottom 14A. The shape of the opening of the first bottom 14A and the cross-sectional shape of the stem 14B are both rectangular rather than circular. Therefore, when the first bottom 14A rotates, the stem 14B also rotates in conjunction with it. The valve 13V is coupled to the stem leg portion 14I of the stem 14B. Therefore, when the stem 14B rotates, the valve 13V also rotates in conjunction with it. This shifts to the second state in Which the valve 13V is open, as illustrated in FIG. 3C.

When the operation valve 10 is shifted from the second state to the first state, the procedure described above may be reversed. In this case, since the operation dial 14 is maintained in the pulled-up state, if the operation dial 14 is rotated clockwise in the peripheral direction by the predetermined amount, the dial steps 14P and 14Q and the storage steps 13P and 13Q are fitted to each other again. This is because the spring 145 always urges the operation dial 14 toward the storage portion 13. Thereby, the second state in which the valve 13V is open can be shifted to the first state in which the valve 13V is closed.

Thus, according to the first embodiment, the opening and closing of the valve 13V can be operated without adopting the operation cock for the operation valve 10. In particular, since the operation dial 14 is pulled up and rotated, the size of the entire operation valve 10 in the first state can be made more compact than in the case where the operation dial is pushed in and rotated. This makes it possible to reduce the possibility of interference with foreign matters (for example, gravel, cloth, etc.) on the road while the vehicle is traveling. When the oil is discharged, the operation dial 14 may be temporarily pulled up and the operation valve 10 may be expanded only at that time.

In a case where the operation dial is pushed in and rotated, the foreign matters may come into contact with the operation dial and the operation dial may be accidentally pushed in and rotated. However, according to the first embodiment, the operation of pulling up and rotating the operation dial 14 can only be carried out manually, which is safer than the case where the operation dial is pushed in and rotated. Furthermore, the number of parts can be reduced compared to second and third embodiments described below.

### SECOND EMBODIMENT

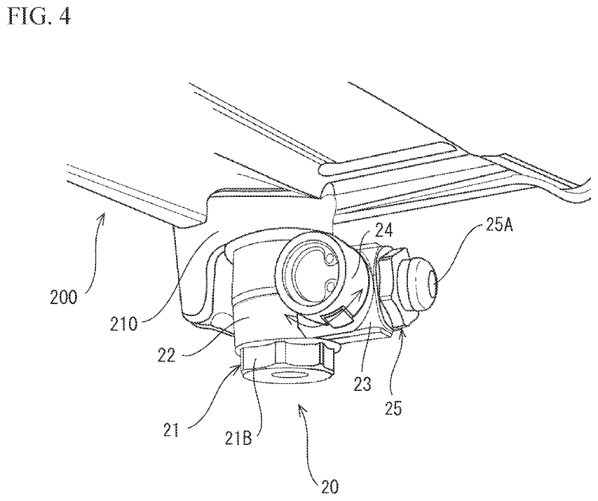

Subsequently, a second embodiment of the present disclosure will be described with reference to FIGS. 4 to 8B. The same configurations as those in the first embodiment are basically designated by corresponding reference numerals, and detailed description thereof will be omitted. The same applies to the third embodiment described later.

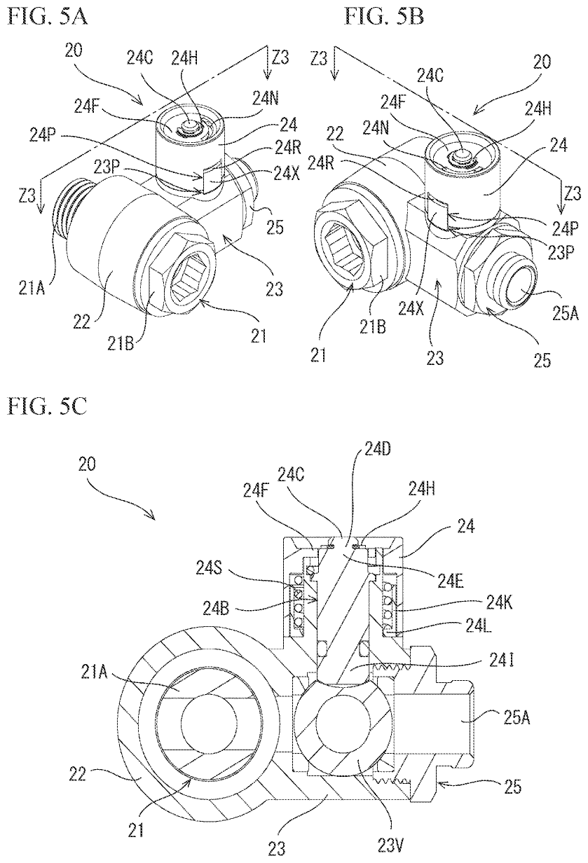

As illustrated in FIG. 4, an operation valve 20 according to the second embodiment is attached to a drain port 210 provided at the bottom of an oil pan 200, as in the first embodiment. When the operation valve 20 is attached to the drain port 210, a hexagon bolt 21 of the operation valve 20 is screwed into the drain port 210. The hexagon bolt 21 is made of a resin or a metal containing duralumin alloy. The tip of a bolt shaft portion 21A (see FIG. 5A) of the hexagon bolt 21 projects from a hollow housing portion 22 included in the operation valve 20. That is, the housing portion 22 houses a portion other than the tip of the bolt shaft portion 21A.

Inside the bolt shaft portion 21A, a flow passage through which the oil flows is formed along a longitudinal direction of the bolt shaft portion 21A. The oil in the oil pan 200 flows into the flow passage from an inlet of the flow passage and flows out from an outlet of the flow passage. The outlet of the flow passage is perpendicular to the flow passage. In other words, the outlet of the flow passage is formed in a diameter-expanding direction of the bolt shaft portion 21A. As a result, the flow direction of the oil changes from the vertical direction to the horizontal direction.

A male screw is provided on the outer peripheral surface of the bolt shaft portion 21A. By connecting a tool such as a spanner to a bolt head 21B of the hexagon bolt 21 and rotating the bolt head 21B in the peripheral direction, the male screw of the bolt shaft portion 21A and the female screw of the drain port 210 are fastened. Thereby, the operation valve 20 can be attached to the drain port 210.

The operation valve 20 includes a storage portion 23. The storage portion 23 has a flow channel that communicates with the outlet of the above-mentioned flow passage therein. The storage portion 23 protrudes in a direction orthogonal to the longitudinal direction of the housing portion 22 from the outer peripheral surface of the housing portion 22 as a reference surface. The flow channel provided inside the storage portion 23 extends in a protruding direction of the storage portion 23. A valve is stored in the middle of the flow passage. The valve can be opened and closed by rotating an operation dial 24 provided as the first operator on the outer peripheral surface of the storage portion 23. For example, when the operation dial 24 is rotated counterclockwise in the peripheral direction from the first state in which the valve is closed, the valve opens. Conversely, when the operation dial 24 is rotated clockwise in the peripheral direction from the second state in which the valve is open, the valve closes.

A fluid discharge portion 25 is provided at the tip of the storage portion 23 in the protruding direction. A flow passage coupled with the above-mentioned flow channel is formed inside the fluid discharge portion 25. Therefore, when the valve described above is opened, the oil is discharged from a fluid discharge port 25A which is the outlet of the flow passage. On the contrary, when the valve is closed, the oil discharge from the fluid discharge port 25A is stopped.

The details of the operation valve 20 will be described with reference to FIG. 5A to 8B. First, as illustrated in FIGS. 5A and 5B, the cylindrical operation dial 24 includes a dial step 24P along the peripheral direction, as the first step parallel to the central axis. The operation dial 24 also includes another dial step (not illustrated) on a portion facing the dial step 24P. The dial step 24P and the another dial step (not illustrated) provided facing the back side of the dial step 24P include two grooves recessed in a reducing-diameter direction of the operation dial 24 as dial grooves 24R. The depths of the dial grooves 24R are the same as each other.

On the other hand, the storage portion 23 includes a storage step 23P on the outer peripheral surface as a second step corresponding to the dial step 24P, in the first state in which a valve 23V is closed. Similarly, a storage step not illustrated in FIGS. 5A and 5B corresponding to the another dial step (not illustrated) located on the back side of the dial step 24P is also provided. The storage step 23P includes a groove recessed toward the storage portion 23 as a storage groove 23R. Similarly, a storage step not illustrated in FIGS. 5A and 5B includes a storage groove. The depths of the storage groove 23R and the storage groove (not illustrated) are the same as each other.

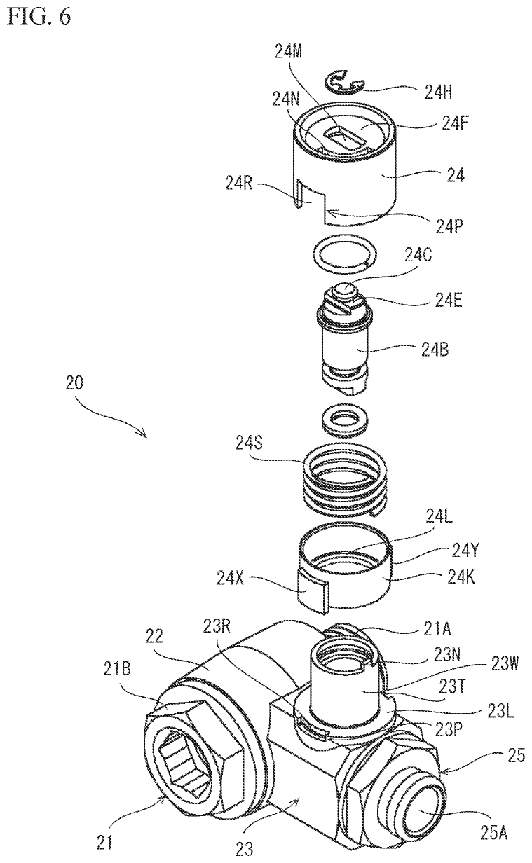

As illustrated in FIGS. 5C and 6, the operation dial 24 includes a disk portion 24F as a raised bottom at the end of the cylinder, and a substantially rectangular opening 24M is provided near the center of the disk portion 24F. FIG. 6 illustrates an exploded state of an operation mechanism including the operation dial 24. Unlike the first embodiment, the disk portion 24F is integrated with the operation dial 24. Further, the disc portion 24F includes an arc-shaped opening 24N along the periphery of the disc portion 24F. A cylindrical lock cylinder 24K is arranged inside the operation dial 24 as a second operator. The outer diameter of the lock cylinder 24K is equal to the inner diameter of the operation dial 24. Therefore, when the lock cylinder 24K is arranged inside the operation dial 24, the outer peripheral surface of the lock cylinder 24K comes into contact with the inner peripheral surface of the operation dial 24.

As illustrated in FIGS. 5C and 6, a ring-shaped pedestal 24L is provided at the lower end of the inner periphery of the lock cylinder 24K. A spring 24S is mounted on the pedestal 24L. Therefore, the outer diameter of the spring 24S is equal to the inner diameter of the lock cylinder 24K, and a seat width of the pedestal 24L is equal to a wire diameter of the spring 24S. Thereby, the spring 24S can be housed and arranged inside the lock cylinder 24K.

Two substantially rectangular lock portions 24X and 24Y protruding in a radial direction from the outer peripheral surface are provided on the outer peripheral surface of the lock cylinder 24K. The lock portions 24X and 24Y are provided so as to face each other. The heights of the lock portions 24X and 24Y are the same as the height of the lock cylinder 24K, but the lower ends of the lock portions 24X and 24Y protrude from the lower end of the lock cylinder 24K. The protrusion amounts of the lower ends of the lock portions 24X and 24Y are the same as the depths of the storage grooves 23R and 23T. Therefore, the upper ends of the lock portions 24X and 24Y are lowered from the upper end of the lock cylinder 24K by the same amount as the protrusion amount of the lower ends of the lock portions 24X and 24Y.

Thereby, when the lock cylinder 24K is arranged on the outer peripheral surface of the storage portion 23, the restoring force of the spring 24S acts on the pedestal 24L, and the lower end of the lock portion 24X is fitted into the storage groove 23R in the first state where the valve 23V is closed, as illustrated in FIG. 5A. Further, the lower end of the lock portion 24Y is also fitted into the storage groove 23T in the same manner. By fitting the lower ends of the lock portions 24X and 24Y into the storage grooves 23R and 23T, the rotation of the operation dial 24 in the peripheral direction is regulated.

As illustrated in FIG. 6, a cylinder wall 23W is provided between the storage grooves 23R and 23T of the storage portion 23. The cylinder wall 23W stands in a direction orthogonal to both of the longitudinal direction of the hexagon bolt 21 and the longitudinal direction of the storage portion 23. A protrusion 23N is formed on an upper surface of the cylinder wall 23W. The protrusion 23N fits into the opening 24N of the disk portion 24F. Although the details will be described later, it is possible to determine whether the operation valve 20 is in the first state in which the valve 23V is closed or in the second state in which the valve 23V is opened, depending on the position of the protrusion 23N appearing in the opening 24N.

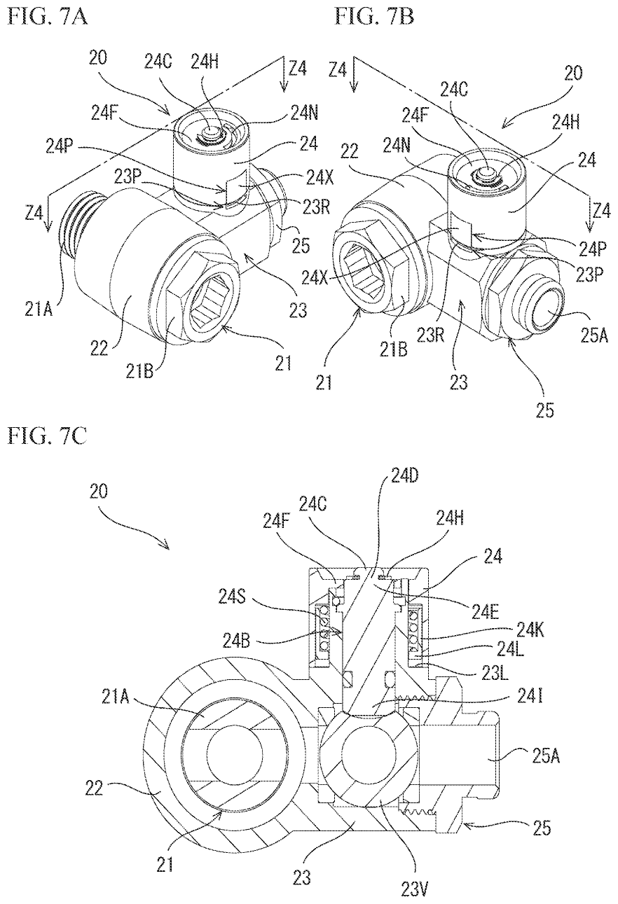

When the valve 23V is opened, the lock portion 24X and the lock portion 24Y (see FIG. 6) provided so as to face the lock portion 24X are grasped by two fingers of one hand and pulled up toward the disk portion 24F, as illustrated in FIGS. 7A and 7B. Since the operation dial 24 is provided with the dial groove 24R (see FIG. 6), the lock portion 24X can be pulled up. Since the operation dial 24 is provided with a similar dial groove facing the dial groove 24R (not illustrated), the lock portion 24Y can also be pulled up in the same manner.

Thereby, the lock portion 24X is released from the fitting with the storage groove 23R. The lock portion 24Y is similarly released from the storage groove 23R at the same time as the lock portion 24X is released. When the lock portions 24X and 24Y are released, the pedestal 24L of the lock cylinder 24K is separated from the seat surface 23L (see FIG. 6) on the outer peripheral surface of the storage portion 23, as illustrated in FIG. 7C. As a result, the step between the lower end of the lock portion 24X and the storage step 23P is eliminated as illustrated in FIGS. 7A and 7B. Similarly, the step is eliminated for the lock portion 24Y. Thus, the regulation on the rotation of the operation dial 24 in the peripheral direction by the lock portions 24X and 24Y is released, and the operation valve 20 is in an intermediate state in which the operation dial 24 can rotate. Even in the intermediate state, the valve 23V is in the closed state, as illustrated in FIG. 7C.

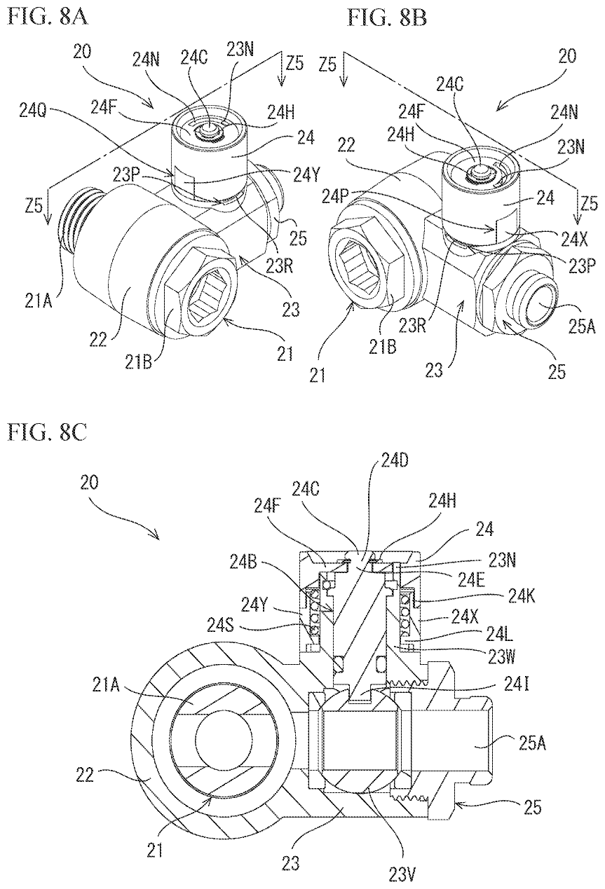

When the operation valve 20 is in the intermediate state in which the operation dial 24 can rotate, the operation dial 24 is rotated counterclockwise in the peripheral direction. Thereby, the lock portion 24Y is located so as to face the housing portion 22, as illustrated in FIG. 8A. Further, the lock portion 24X is located in the same direction as the fluid discharge portion 25, as illustrated in FIG. 8B. Further, the protrusion 23N moves relatively to a position different from the position before rotation. The disk portion 24F is provided with a substantially rectangular opening 24M, and a stem 24B including a stem shoulder portion 24E having a rectangular cross section is inserted through the opening 24M. Since the disk portion 24F is integrated with the operation dial 24, when the operation dial 24 rotates, the stem 24B also rotates in the same direction in conjunction with the rotation of the operation dial 24. Therefore, the valve 23V coupled to a stem leg portion 24I of the stem 24B also rotates. This completes the shift from the first state in which the valve 23V is closed to the second state in which the valve 23V is opened. Further, by confirming the position of the protrusion 23N, it is possible to easily determine whether the operation valve 20 is in the first state or the second state.

When the operation valve 20 is shifted from the second state to the first state, the procedure described above may be reversed. In this case, since the lock cylinder 24K is maintained in the pulled-up state, if the lock cylinder 24K is rotated clockwise in the peripheral direction by the predetermined amount, the lower ends of the lock portions 24X and 24Y fit into the storage grooves 23R and 23T again. This is because the spring 24S always urges the lock cylinder 24K toward the storage portion 23. Thereby, the second state in which the valve 23V is open can be shifted to the first state in which the valve 23V is closed. Since the lock cylinder 24K is maintained in the pulled-up state, the operation dial 24 may be rotated clockwise in the peripheral direction by the predetermined amount instead of rotating the lock cylinder 24K clockwise in the peripheral direction by the predetermined amount. The lock cylinder 24K also rotates together with the rotation of the operation dial 24, and the lower ends of the lock portions 24X and 24Y fit into the storage grooves 23R and 23T.

As described above, according to the second embodiment, the opening and closing of the valve 23V can be operated without adopting the operation cock for the operation valve 20. In the first embodiment, the operation valve 10 is pulled up, but in the second embodiment, the lock cylinder 24K is pulled up and rotated without pulling up the operation valve 20. As a result, the size of the entire operation valve 20 can be made compact as compared with the case where the operation dial is pushed in and rotated. As in the first embodiment, the safety is increased as compared with the case where the operation dial is pushed in and rotated. Further, in the second embodiment, the operation dial 24 and the lock cylinder 24K are independent and different parts, and the operation dial 24 and the lock cylinder 24K are interlocked to open and close the valve 23V. Therefore, regarding the opening and closing of the valve 23V, it is possible to reduce malfunctions as compared with the first embodiment. In the second embodiment, although the lock cylinder 24K is pulled up, the operation dial 24 itself is not pulled up. Therefore, unlike the first embodiment in which the operation dial 14 itself is pulled up, the position of a zenith edge of the operation dial 24 does not change before and after opening and closing the valve 23V, and the operation dial 24 can avoid interfering with parts near the operation dial 24.

### THIRD EMBODIMENT

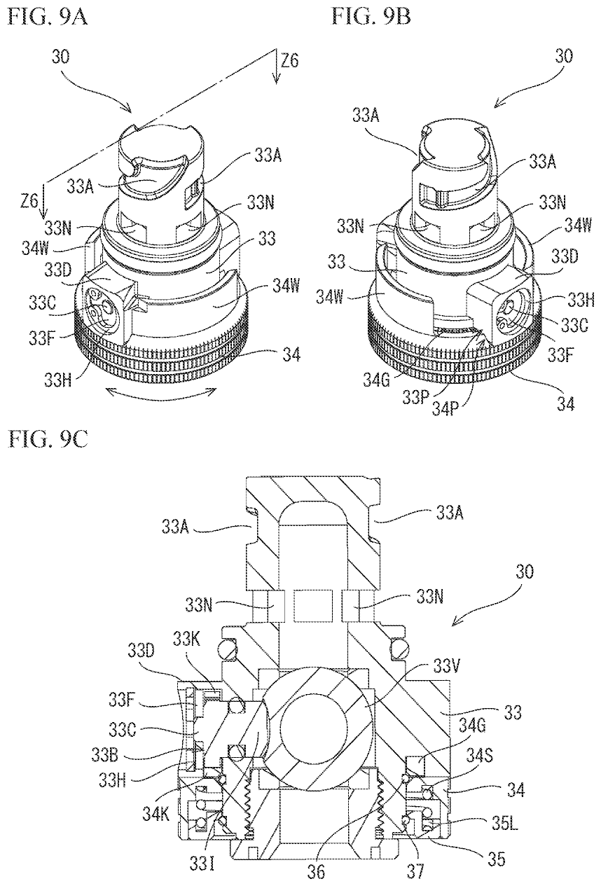

Subsequently, a third embodiment of the present invention will be described with reference to FIGS. 9A to 12C. Instead of the male screw 13A described above, a cam groove 33A is formed on the head of a storage portion 33 of an operation valve 30 according to the third embodiment, as illustrated in FIGS. 9A to 9C. Therefore, when an adapter mechanism (not illustrated) having a protrusion guided by the cam groove 33A may be provided on the depth side of the drain port 110 instead of the female screw 111 provided on the inner periphery of the drain port 110 described above, the adapter mechanism and the cam groove 33A can be mechanically coupled.

This allows the operation valve 30 to be attached horizontally to the oil pan 100. The oil in the oil pan 100 flows into the inside of the storage portion 33 through a plurality of inlets 33N provided in the storage portion 33. The storage portion 33 has a flow channel for the oil therein. Therefore, the oil that has flowed into the storage portion 33 flows through the flow channel of the storage portion 23 and is discharged from the outlet of the flow channel.

Instead of mechanically connecting the adapter mechanism and the cam groove 33A, a male screw may be provided on the outer periphery of the head of the storage portion 33 as in the first embodiment. In this case, as in the first embodiment, the head of the storage portion 33 may be hollow in the longitudinal direction. Further, the adapter mechanism may be provided on the depth side of the drain port 210, and the operation valve 30 may be vertically attached to the oil pan 200.

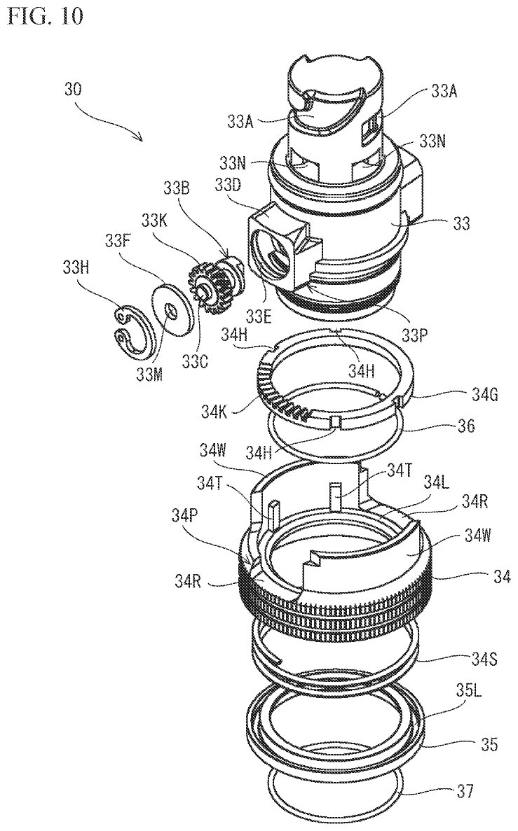

As illustrated in FIG. 10, the operation valve 30 includes the storage portion 33, a cylindrical operation dial 34 as an operator, a ring gear 34G, a spring 34S, a dial cover 35, and snap rings 36 and 37 in the longitudinal direction of the operation valve 30. The ring gear 34G is a ring-type face gear. Further, the operation valve 30 includes a stem 33B, a disk portion 33F, and a snap ring 33H arranged in the radial direction of the storage portion 33 on the outer periphery of the storage portion 33.

A spur gear 33K is provided on a stem head portion 33C of the stem 33B. The cross section of the stem head portion 33C is circular. The stem head portion 33C penetrates the spur gear 33K and protrudes from the spur gear 33K. A circular opening 33M is provided near the center of the disk portion 33F. The inner diameter of the opening 33M is equal to the outer diameter of the cross section of the stem head portion 33C. Therefore, the stem head portion 33C can be fitted into the opening 33M of the disk portion 33F.

As illustrated in FIGS. 9A to 9C, the stem 33B, the disk portion 33F, and the snap ring 33H are housed inside a substantially square cylinder type lock mechanism 33D. The lock mechanism 33D is provided on the outer peripheral surface of the storage portion 33. As illustrated in FIGS. 9B and 10, the lock mechanism 33D includes a storage step 33P as the second step. The storage step 33P is formed in the radial direction of the storage portion 33. As illustrated in FIG. 10, a ring groove 33E is formed on the inner periphery of the lock mechanism 33D. When the stem 33B, the disk portion 33F and the snap ring 33H are housed inside the lock mechanism 33D in this order, the snap ring 33H fits into the ring groove 33E. This makes it possible to prevent the snap ring 33H from falling off from the lock mechanism 33D. By preventing the snap ring 33H from falling off, it is also possible to prevent the stem 33B and the disk portion 33F housed in a deeper side than the snap ring 33H in the lock mechanism 33D from falling off.

As illustrated in FIG. 10, the ring gear 34G is arranged between the storage portion 33 and the operation dial 34. The ring gear 34G is prevented from falling from the operation valve 30 by the snap ring 36 that fits with the outer periphery of the bottom portion of the storage portion 33, as illustrated in FIG. 9C. The outer diameter of the ring gear 34G is substantially the same as the inner diameter of the operation dial 34. A plurality of recesses 341 recessed in the radial direction of the ring gear 34G are provided on the outer periphery of the ring gear 34G. Further, a gear portion 34K is formed on a part of the top surface of the ring gear 34G located between the two recesses 34H. The gear portion 34K is gear-coupled with the spur gear 33K housed in the lock mechanism 33D. Therefore, when the ring gear 34G rotates in the peripheral direction, the spur gear 33K also rotates in conjunction with the rotation of the ring gear 34G. When the spur gear 33K rotates, the stem 33B provided with the spur gear 33K also rotates. Since a valve 33V is coupled to a stem leg portion 33I of the stem 33B as illustrated in FIG. 9C, when the stem 33B rotates, the valve 33V also rotates.

As illustrated in FIG. 10, the ring gear 34G is mounted on a pedestal 34L provided on the inner periphery of the operation dial 34. A plurality of columns 34T including protrusions protruding inward in the radial direction of the operation dial 34 are provided on the top surface of the pedestal 34L. The plurality of columns 34T are provided along each of the inner peripheries of two curved walls 34W of the operation dial 34, and are fitted into the plurality of recesses 34H included in the ring gear 34G, respectively. Therefore, when the operation dial 34 rotates in the peripheral direction, the ring gear 34G also rotates in the peripheral direction in conjunction with the rotation of the operation dial 34.

Two dial grooves 34R recessed in the longitudinal direction of the operation dial 34 are provided between the two curved walls 34W of the operation dial 34. Each of the dial groove 34R forms a dial step 34P as the first step. As illustrated in FIGS. 9A and 9B, the bottom portion of the lock mechanism 33D is fitted into the dial groove 34R. That is, the dial step 34P corresponds to the storage step 33R. By fitting the bottom of the lock mechanism 33D into the dial groove 34R, the rotation of the operation dial 34 in the peripheral direction is regulated.

As illustrated in FIGS. 9C and 10, the cylindrical dial cover 35 is arranged on the bottom of the operation dial 34. The dial cover 35 covers a space existing inside the bottom of the operation dial 34. A ring-shaped spring storage groove 35L is formed in a cylinder wall of the dial cover 35. The spring 34S is placed and stored in the spring storage groove 35L. As illustrated in FIG. 9C, the dial cover 35 is prevented from falling from the operation valve 30 by the snap ring 37 that fits with the outer periphery of the bottom portion of the storage portion 33. Therefore, by preventing the dial cover 35 from falling off, it is also possible to prevent the operation dial 34 from falling off from the operation valve 30.

Since the dial cover 35 is positioned by the snap ring 37, the restoring force of the spring 345 stored in the spring storage groove 35L always acts on the operation dial 34. That is, the spring 34S always urges the operation dial 34 toward the head of the storage portion 33. Thereby, in the first state in which the valve 33V is closed, the bottom portion of the lock mechanism 33D always fits into the dial groove 34R, as illustrated in FIGS. 9A and 9B. As a result, the rotation of the operation dial 34 in the peripheral direction is regulated.

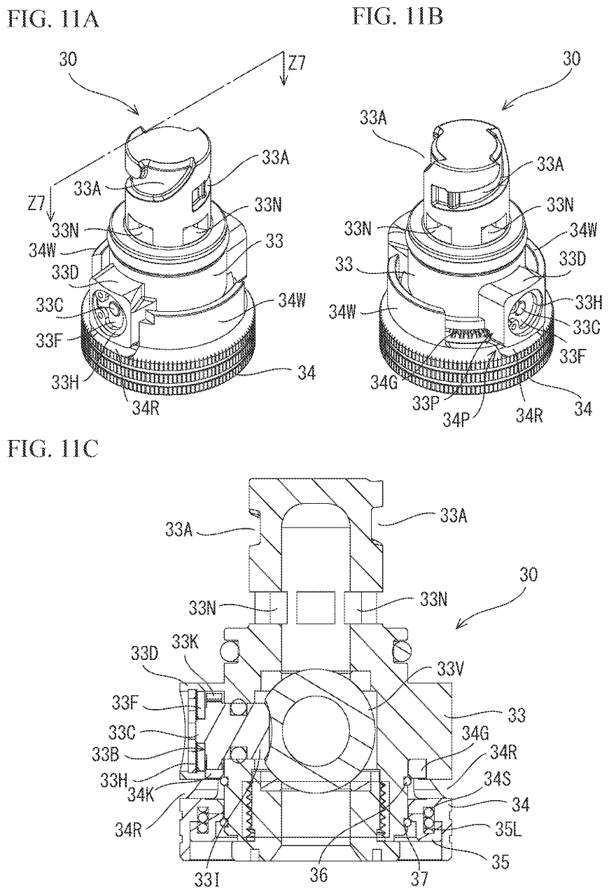

When the valve 33V is opened, the operation dial 34 is first grasped by the two fingers of one hand, and pulled down toward the dial cover 35, as illustrated in FIGS. 11A to 11C. Thereby, the bottom portion of the lock mechanism 33D is released from the fitting with the dial groove 34R. At this time, since the ring gear 34G is positioned by the snap ring 36, when the operation dial 34 is pulled down, the plurality of recesses 34H of the ring gear 34G slide relatively on the corresponding columns 34T. When the lock mechanism 33D is released, the step between the bottom surface of the lock mechanism 33D and the bottom surface of the dial step 34P is eliminated. In this way, the regulation on the rotation of the operation dial 34 in the peripheral direction by the lock mechanism 33D is released, and the operation valve 30 is in the intermediate state in which the operation dial 34 can rotate. Even in the intermediate state, the valve 33V is in the closed state, as illustrated in FIG. 11C.

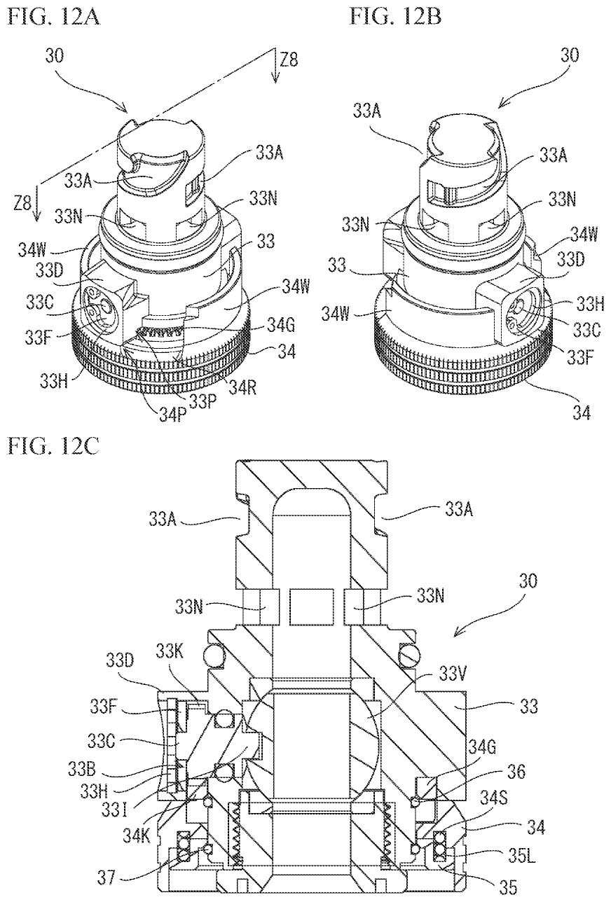

When the operation valve 30 is in the intermediate state in which the operation dial 34 can rotate, the operation dial 34 is rotated counterclockwise in the peripheral direction. Thereby, the lock mechanism 33D slides relatively on the top surface of the dial step 34P, as illustrated in FIGS. 12A and 12B. When the operation dial 34 rotates in the peripheral direction as described above, the ring gear 34G also rotates in the same direction in conjunction with the rotation of the operation dial 34. The gear portion 34K is formed on the ring gear 34G, and the spur gear 33K is gear-coupled to the gear portion 34K. Therefore, when the ring gear 34G rotates, the spur gear 33K also rotates. Since the spur gear 33K is provided on the stem 33B, the stem 33B also rotates in conjunction with the rotation of the spur gear 33K. Therefore, the valve 33V coupled to the stem leg portion 33I of the stem 33B also rotates. This completes the shift from the first state in which the valve 33V is closed to the second state in which the valve 33V is opened.

When the operation valve 30 is shifted from the second state to the first state, the procedure described above may be reversed. In this case, since the operation dial 34 is maintained in the pulled-down state, if the operation dial 34 is rotated clockwise in the peripheral direction by the predetermined amount, the bottom portion of the lock mechanism 33D fits into the dial groove 34R again. This is because the spring 34S always urges the operation dial 34 toward the head of the storage portion 33. Thereby, the second state in which the valve 33V is open can be shifted to the first state in which the valve 33V is closed.

As described above, according to the third embodiment, the opening and closing of the valve 33V can be operated without adopting the operation cock for the operation valve 30. Unlike the first embodiment, the operation dial 34 is pulled down and rotated, but the size of the entire operation valve 30 can be made compact as compared with the case where the operation dial is pushed in and rotated. Since the operation dial is not pushed in and rotated, the safety is increased as compared with the case where the operation dial is pushed in and rotated. In addition, since the operation valve 30 adopts the gear structure, a rotation axis of the valve 33V and a rotation axis of the operation dial 34 are different from each other. As a result, the opening and closing of the valve 33V can be operated with the rotation axis different from the rotation axis of the valve 33V. Further, an operation angle of the operation dial 34 can be freely set by changing a gear ratio, and hence the degree of freedom in designing the operation valve 30 can be improved.

The embodiments of the present disclosure have been described above. However, the embodiments of the present disclosure disclosed above are only illustrative, and the scope of the present invention is not limited to the specific embodiments of the disclosure. It is to be understood that the scope of the present invention is defined in the appended claims and includes equivalence of the description of the claims and all changes within the scope of the claims. For example, slits and knurls may be provided on the outer peripheral surfaces of the operation dials 14, 24 and 34 along the longitudinal direction thereof to suppress slippage between the fingers and the outer peripheral surfaces of the operation dials 14, 24 and 34 and improve operability of the operation dials 14, 24 and 34.

For example, in the first to third embodiments described above, oil has been used as an example of the fluid, but the fluid may be potable water, or may be a flammable or nonflammable gas. The potable water includes, for example, water, soft drinks, alcoholic beverages and the like.

What is claimed is:

1. An operation valve comprising:
a valve that controls the flow of a fluid;
a cylindrical operator that operates opening and closing of the valve by rotating the operator in a peripheral direction, and has a first step parallel to a central axis of the operator;
a storage that stores the valve, includes a flow channel of the fluid therein, and has a second step corresponding to the first step on an outer periphery of the storage in a first state in which the valve is closed; and
an elastic body that urges the operator toward the storage.

2. The operation valve according to claim 1, wherein
the first step and the second step fit into each other to regulate the rotation of the operator.

3. The operation valve according to claim 2, wherein
each of the first step and the second step has two steps having different heights, one of the steps regulates the rotation of the operator from the first state to a second state in which the valve is opened, and the other of the steps regulates excessive rotation of the operator.

4. The operation valve according to claim 1, wherein
the operator includes a cylindrical first operator that operates the opening and closing by the rotation of the first operator, and a cylindrical second operator that regulates the rotation of the first operator by fitting the second operator into both of a first groove included in the first step and a second groove included in the second step.

5. The operation valve according to claim 4, wherein
the first operator has a disk member at one end thereof, the disk member including an arc-shaped opening along a periphery of the first operator, and
the storage extends parallel to a central axis of the first operator and includes a protrusion protruding from the opening.

6. The operation valve according to claim 5, wherein
one end of the opening is provided at a position representing the first state, and the other end of the opening is provided at a position representing a second state in which the valve is opened.

7. The operation valve according to claim 1, wherein
the storage has the second step on an outer periphery of the storage, and
the second step fits into a groove of the first step to regulate the rotation of the operator.

8. The operation valve according to claim 7, wherein
the operator holds a ring-shaped face gear along an inner periphery of the operator, and
the storage includes a stem having the valve connected to one end of the stem and a spur gear to be coupled to the face gear at the other end of the stem.
